(19) United States
(12) Patent Application Publication
(10) Pub. No.: US 2026/0095456 A1
(43) Pub. Date: Apr. 2, 2026

(54) System and method for generating a dynamic user interface

(71) Applicant: Bank of America Corporation, Charlotte, NC (US)

(72) Inventors: Nipun Mahajan, Lawrenceville, NJ (US); Krithika Viswanathan, Chennai (IN); Amit Mishra, Chennai (IN); Yogesh Raghuvanshi, Pennington, NJ (US); Shiva Prasad S, Chennai (IN)

(21) Appl. No.: 18/904,019

(22) Filed: Oct. 1, 2024

(51) Int. Cl. H04L 9/40; G06F 9/451; G06T 11/00

(52) U.S. Cl. CPC H04L 63/102; G06F 9/451; G06T 11/00; G06T 2200/24

(57) ABSTRACT

A virtual environment is provided that dynamically adapts user interface (UI) elements presented/displayed within the virtual environment based on a user profile of a user navigating the virtual environment. A user profile associated with a user includes a set of UI elements that the user is authorized to view/access and/or is relevant to the user. As the user navigates the virtual environment, a processor renders only those UI elements for display to a user device of the user that are associated with the user profile of the user and does not render UI elements that are not associated with the user profile of the user.

### TECHNICAL FIELD

The present disclosure relates generally to network communication, and more specifically to a system and method for generating a dynamic user interface.

### BACKGROUND

In conventional systems, a virtual environment (e.g., a metaverse environment) is configured to present/display to a user all or most user interface (UI) elements that are configured in the field of view of the user within the virtual environment regardless of whether a UI element is relevant to the user or whether the user is authorized to view/access a UI element. Rendering all or most UI elements of the virtual environment consumes a large amount of computing resources. Further, displaying UI elements in the virtual environment that a user is not authorized to view and/or access may compromise data security and facilitate data theft.

### SUMMARY

The system and methods implemented by the system as disclosed in the present disclosure provide technical solutions to the technical problems discussed above by generating a user interface for a virtual environment that dynamically adapts UI elements based on authorization of users and/or relevancy to the users navigating the virtual environment.

For example, the disclosed system and method provide the practical application of generating a virtual environment that dynamically adapts UI elements presented/displayed within the virtual environment based on a user profile of a user navigating the virtual environment. For example, as described in embodiments of the present disclosure, a user profile associated with a user includes a set of UI elements that the user is authorized to view/access and/or is relevant to the user. As the user navigates the virtual environment, a virtual-world server renders only those UI elements for display to the user device of the user that are associated with the user profile of the user and does not render UI elements that are not associated with the user profile of the user.

By processing and rendering only those UI elements that are associated with the user profile of the viewing user, the virtual-world server processes and renders only a portion of the overall UI elements that are configured for the virtual environment. For example, conventional systems render all or most UI elements of a virtual environment without consideration to whether one or more of the rendered UI elements are irrelevant for a user or whether the user is authorized to view/access one or more rendered UI elements. However, by rendering only a subset of UI elements (versus all UI elements) that are associated with a user profile of a user, the disclosed system method render a smaller number of UI elements. Processing and rendering a smaller number of UI elements saves computing resources (e.g., processing and memory resources) of the virtual-world server. This improves the processing efficiency of the virtual-world server. Further, since a smaller number of UI elements are processed and rendered, the data files (including rendered images/frames of the virtual environment) transmitted by the virtual-world server to the user device of the user are also smaller, thus using lesser network bandwidth. For example, every time a new field of view including a new set of UI elements within the virtual environment is to be rendered for display on the user device, the virtual-world server renders the new field of view and transmits over a data network to the user device a data file including rendered images/frames of the new field of view. In conventional systems, as all or most UI elements in a given field of view are rendered, the data files containing the rendered images/frames transmitted to the user device tend to be large in size, thus consuming large network bandwidth. However, by rendering only a subset of UI elements (versus all UI elements) that are associated with a user profile of a user, the data files generated and transmitted by the virtual-world server to the user device are relatively smaller in size, thus saving network bandwidth. This improves the network efficiency of a network used to transmit these data files to the user device. Accordingly, the system and methods shown described in embodiments of the present disclosure improve computing technology and networking technology.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of a system, in accordance with certain aspects of the present disclosure;

FIG. 2 is a block diagram of an embodiment of the first user device used by the system of FIG. 1; and

FIG. 3 illustrates a flowchart of an example method for generating a dynamic virtual environment, in accordance with one or more embodiments of the present disclosure.

### DETAILED DESCRIPTION

### Example System

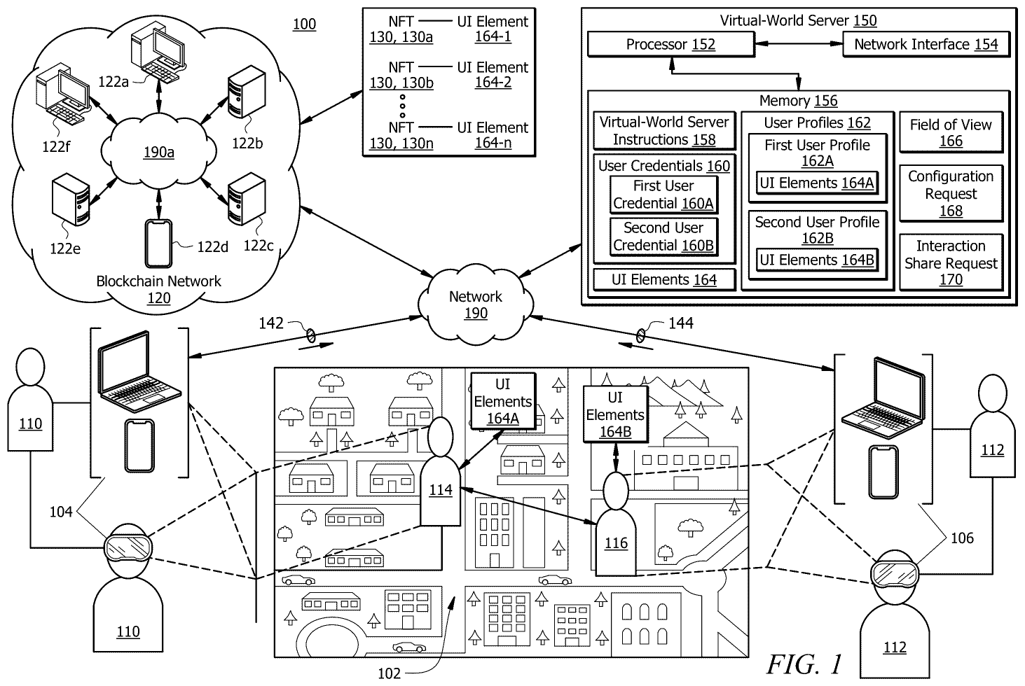

FIG. 1 is a schematic diagram of a system 100, in accordance with certain aspects of the present disclosure. System 100 may include a first user device 104, a second user device 106, a virtual-world server 150, and a blockchain network 120 each connected to a network 190. A first user 110 is associated with the first user device 104 and a second user 112 is associated with the second user device 106. The system 100 may be communicatively coupled to the communication network 190 and may be operable to transmit data between each one of the first user device 104, second user device 106, virtual-world server 150, and the blockchain network 120 through the communication network 190. As further described below, the virtual-world server 150 may be configured to provide users (e.g., users 110 and 112) access to a virtual environment 102 (e.g., a metaverse environment) and allow users to perform any kind of action or interaction within the virtual environment 102. For example, the virtual-world server 150 may provide users (e.g., users 110, 112) access to products, services and/or experiences within the virtual environment 102.

It may be noted that the terms “real-world” and “real-world environment” in this disclosure refer to any non-virtual environment where users (e.g., users 110 and 112) can physically interact with real persons and objects. A real-world data interaction may refer to any data interaction performed outside the virtual environment 102 (e.g., a metaverse environment). Further, it may be noted that while certain embodiments of the present disclosure may be described in the context of a metaverse environment which is an example of a virtual environment 102, the methods discussed in this disclosure apply to any other virtual environment 102. The terms “virtual environment” and “metaverse environment” are used interchangeably throughout this disclosure. Furthermore, it may be noted that while certain embodiments of this disclosure describe one or more operations in relation to the first user 110, these embodiments apply to any other user (e.g., second user 112) connected to network 195. Further, while certain embodiments of the present disclosure describe one or more data interactions performed in the virtual environment 102 between the first user 110 and the second user 112, these embodiments apply data interactions between any number of users within the virtual environment 102.

In general, embodiments of the present disclosure describe a system and method for generating a virtual environment that dynamically adapts UI elements presented/displayed within the virtual environment based on a user profile of a user navigating the virtual environment. For example, as described in embodiments of the present disclosure, a user profile associated with a user includes a set of UI elements that the user is authorized to view/access and/or is relevant to the user. As the user navigates the virtual environment, a virtual-world server renders only those UI elements for display to the user device of the user that are associated with the user profile of the user and does not render UI elements that are not associated with the user profile of the user.

The first user 110 may access the virtual environment 102 (e.g., a metaverse environment) through the first user device 104. The first user device 104 is configured to display a two-dimensional (2D) or three-dimensional (3D) representation of the virtual environment 102 to the first user 110. Examples of a virtual environment 102 may include, but are not limited to, a graphical or virtual representation of a metaverse, a map, a building interior, a landscape, a fictional location, an alternate reality, or any other suitable type of location or environment, which may collectively be referred to as UI elements 164. In one embodiment, the virtual environment 102 may include one or more user interface (UI) elements 164 that allow a user (e.g., first user 110) to perform one or more data interactions within the virtual environment 102. For example, the virtual environment 102 may include UI elements 164 such as forms, menus, widgets, buttons, links, fields, and/or any other input controls, navigational components, information components and content containers. The virtual environment 102 may be configured to use realistic or non-realistic physics for the motion of objects within the virtual environment 102. For example, some virtual environments 102 may be configured to use gravity whereas other virtual environments 102 may not be configured to use gravity. Within the virtual environment 102, each user may be associated with an avatar (such as the first avatar 114 for the first user 110). An avatar is a graphical representation of a user at a virtual location within the virtual environment 102. In embodiments, the virtual location of the avatar may be correlated to the physical location of a user in the real-world environment. Examples of an avatar may include, but are not limited to, a person, an animal, or an object. In some embodiments, the features and characteristics of the avatar may be customizable, and user defined. For example, the size, shape, color, attire, accessories, or any other suitable type of appearance features may be specified by a user. By using an avatar, a user is able to move within the virtual environment 102 to interact with one or more avatars and objects within the virtual environment 102 while independently remaining at a physical location in the real-world environment or being in transit in the real-world environment.

While engaging in the virtual environment 102 via the first avatar 114, the first user 110 may interact with a plurality of other users, objects and/or entities through a respective avatar. For example, the second user 112 may attempt to engage in an interaction session with the first avatar 114 through a second avatar 116 associated with the second user 112. In another example, the first avatar 114 of the first user 110 may access a virtual sub-environment (not shown) within the virtual environment 102 and perform virtual data interactions within the virtual sub-environment. The virtual sub-environment may represent a private virtual space within the virtual environment 102 that may be used by the first user 110 and the second user 112 to engage in a shared data session/interaction. In the real-world environment, the second user 112 may be physically located at a distance away from the first user 110. The second user 112 may access the virtual environment 102 through the second user device 106 to control the second avatar 116 and attempt to engage in an interaction session with the first user 110 through the first avatar 114.

Before the interaction between the first avatar 114 and the second avatar 116 occurs, the virtual-world server 150 may authenticate that the first avatar 114 and second avatar 116 are associated with the respective first user 110 and second user 112 and not unauthorized third-parties. In one or more embodiments, the virtual-world server 150 may employ single sign-on (SSO), multifactor authentication, or any other suitable authentication scheme in order to authenticate identity of a user (e.g., first user 110, second user 112) and the user's associated avatar (e.g., first avatar 114, second avatar 116) and allow the users to enter the virtual environment 102 and perform data interactions within the virtual environment 102.

The virtual-world server 150 may store a user profile 162 associated with each user (e.g., first user 110, second user 112). As shown in FIG. 1, the virtual-world server 150 stores a first user profile 162a associated with the first user 110 and second user profile 162b associated with the second user 112. The user profile 162 associated with a user (e.g., first user 110) includes information related to the user including, but not limited to, account information (e.g., including identity and other details relating to one or more virtual data files of the user stored at the virtual-world server 150), avatar information, digital assets information (e.g., virtual data objects stored in the user's virtual data files), or any other suitable type of information that is associated with a user within the virtual environment 102. As further described below, user profile 162 associated with a user (e.g., first user 110, second user) may include a set of UI elements 164 the user is authorized to view/access within the virtual environment 102. For example, as shown in FIG. 1, the first user profile 162a includes a first set of UI elements 164a that the first user 110 is authorized to view/access in the virtual environment 102. Similarly, the second user profile 162b includes a second set of UI elements 164b that the second user 112 is authorized to view/access in the virtual environment 102. In one or more embodiments, as further described below in detail, the virtual-world server 150 may be configured to implement a dynamic user interface for the virtual environment 102 that adapts, in real-time, UI elements 164 associated with the virtual environment 102 based on user profiles 162 associated with users (e.g., first user 110, second user 112).

As shown in FIG. 1, virtual-world server 150 comprises a processor 152, a memory 156, and a network interface 154. The processor 152 comprises one or more processors operably coupled to the memory 156. The processor 152 is any electronic circuitry including, but not limited to, state machines, one or more central processing unit (CPU) chips, logic units, cores (e.g. a multi-core processor), field-programmable gate array (FPGAs), application specific integrated circuits (ASICs), or digital signal processors (DSPs). The processor 152 may be a programmable logic device, a microcontroller, a microprocessor, or any suitable combination of the preceding. The processor 152 is communicatively coupled to and in signal communication with the memory 156. The one or more processors are configured to process data and may be implemented in hardware or software. For example, the processor 152 may be 8-bit, 16-bit, 32-bit, 64-bit or of any other suitable architecture. The processor 152 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components.

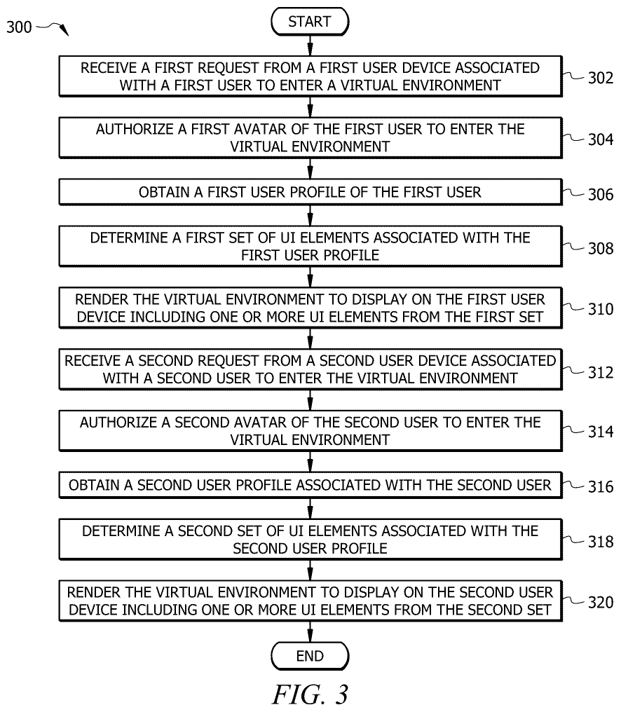

The one or more processors are configured to implement various instructions. For example, the one or more processors are configured to execute instructions (e.g., virtual-world server instructions 158) to implement the virtual-world server 150. In this way, processor 152 may be a special-purpose computer designed to implement the functions disclosed herein. In one or more embodiments, the virtual-world server 150 is implemented using logic units, FPGAs, ASICs, DSPs, or any other suitable hardware. The virtual-world server 150 is configured to operate as described with reference to FIGS. 1 and 3. For example, the processor 152 may be configured to perform at least a portion of the method 300 as described in FIG. 3.

The memory 156 includes a non-transitory computer-readable medium such as one or more disks, tape drives, or solid-state drives, and may be used as an over-flow data storage device, to store programs when such programs are selected for execution, and to store instructions and data that are read during program execution. The memory 156 may be volatile or non-volatile and may comprise a read-only memory (ROM), random-access memory (RAM), ternary content-addressable memory (TCAM), dynamic random-access memory (DRAM), and static random-access memory (SRAM).

The memory 156 is operable to store the virtual-world server instructions 158, user credentials 160, user profiles 162, UI elements 164 associated with the virtual environment 102, fields of view 166, configuration requests 168, and interaction share requests 170. The virtual-world server instructions 158 may include any suitable set of instructions, logic, rules, or code operable to execute the virtual-world server 150.

The network interface 154 is configured to enable wired and/or wireless communications. The network interface 154 is configured to communicate data between the virtual-world server 150 and other devices, systems, or domains (e.g., user devices 104 and 106, and computing nodes 122a-122f of the blockchain network 120). For example, the network interface 154 may comprise a Wi-Fi interface, a LAN interface, a WAN interface, a modem, a switch, or a router. The processor 152 is configured to send and receive data using the network interface 154. The network interface 154 may be configured to use any suitable type of communication protocol as would be appreciated by one of ordinary skill in the art.

In one or more embodiments, the virtual-world server 150 is generally a suitable server (e.g., including a physical server and/or virtual server) operable to store data in a memory (e.g., memory 156) and/or provide access to application(s) or other services. The virtual-world server 150 may be a backend server associated with a particular entity (e.g., organization) that facilitates conducting data interactions between entities, between one or more users, and/or between a user and an entity. In other embodiments, the virtual-world server 150 may be organized in a distributed manner, or by leveraging cloud computing technologies. Virtual-world server 150 may store information which is primarily used to support data interactions performed in the virtual environment 102 (e.g., a metaverse environment). It may be noted that the operations performed by the virtual-world server 150 described in embodiments of the present disclosure may be implemented by a single server.

The communication network 190 may facilitate communication within the system 100. This disclosure contemplates the communication network 190 being any suitable network operable to facilitate communication between the first user device 104, second user device 106, virtual-world server 150, and the computing nodes 122a-122f of the blockchain network 120. Communication network 190 may include any interconnecting system capable of transmitting audio, video, signals, data, messages, or any combination of the preceding. Communication network 190 may include all or a portion of a local area network (LAN), a wide area network (WAN), an overlay network, a software-defined network (SDN), a virtual private network (VPN), a packet data network (e.g., the Internet), a mobile telephone network (e.g., cellular networks, such as 4G or 5G), a Plain Old Telephone (POT) network, a wireless data network (e.g., WiFi, WiGig, WiMax, etc.), a Long Term Evolution (LTE) network, a Universal Mobile Telecommunications System (UMTS) network, a peer-to-peer (P2P) network, a Bluetooth network, a Near Field Communication network, a Zigbee network, and/or any other suitable network, operable to facilitate communication between the components of system 100. In other embodiments, system 100 may not have all of these components and/or may have other elements instead of, or in addition to, those above.

As shown in FIG. 1, blockchain network 120 includes computing nodes 122a, 122b, 122c, 122d, 122e, and 122f connected to each other via a portion of the network 190 (shown as 190a). One or more of the computing nodes 122a-f of the blockchain network 120 may be a Non-Fungible Token (NFT) minting node (e.g., minting server/processor) that is configured to generate NFTs 130. The blockchain network 120 implements distributed computing which generally refers to a method of making multiple computers (e.g., computing nodes 122a-122f) work together to solve a common problem. This makes a computer network (e.g., blockchain network 120) appear as a powerful single computer that provides large-scale resources to deal with complex challenges. For example, distributed computing can encrypt large volumes of data, solve complex physics and chemical equations with many variables, and render high-quality, three-dimensional video animation. Distributed computing often uses specialized software applications that are configured to run on several computing nodes 122 instead of on just one computer, such that different computers perform different tasks and communicate to develop the final solution. High-performing distributed computing is often used in engineering research, financial services, energy sector and the like to run complex processes.

Blockchain network 120 may implement a blockchain across a plurality of the computing nodes 122 (e.g., computing nodes 122a-122f). A blockchain generally is an open, decentralized and distributed digital ledger consisting of records called blocks that are used to record data interactions across many computing nodes (e.g., computing nodes 122). Each computing node 122 of a blockchain network (e.g., blockchain network 120) may maintain a copy of the blockchain ledger. Logically, a blockchain is a chain of blocks which contains specific information. Once recorded, the data in any given block cannot be altered retroactively without alteration of all subsequent blocks, which requires consensus of the network majority. Each computing node 122 within the blockchain network 120 maintains, approves, and updates new entries. The system is controlled not only by separate individuals, but by everyone within the blockchain network 120. Each member ensures that all records and procedures are in order, which results in data validity and security. Thus, the distributed ledger can record data interactions between two parties (e.g., users 110, 112) efficiently and in a verifiable and permanent way. By design, a blockchain is resistant to modification of the data. In one embodiment, as discussed below in more detail, the blockchain network 120 may store (e.g., in the blockchain ledger maintained on one or more computing nodes 122) a plurality of NFTs 130 (shown as NFTs 130a-130n), wherein each NFT 130 is associated with a particular UI element 164 of the virtual environment and uniquely identifies the particular UI element 164. As shown, NFTs 130a, 130b, and 130n are associated with and uniquely identify UI elements 164-1, 164-2 and 164-n respectively.

Any new interaction or activity within the blockchain network may trigger the building of a new block of the blockchain. An interaction may include a computing node 122 of the blockchain network transmitting or receiving data from another computing node 122 of the blockchain network 120 or from a computing node that is not part of the blockchain network. Before a new block is added to the blockchain, it needs to be verified by a majority of the computing nodes in the blockchain network 120. Each block of the blockchain includes a hash of the block, a hash of the previous block, data that records one or more data interactions or activities associated with the block, and a timestamp of the one or more interactions or activities recorded by the block. The data stored in each block depends on the type of blockchain. For example, the data included in a block may include information relating to the data interaction recorded by the block including transmitting/receiving data, details of the data files, a copy of data received or generated as part of the interaction, identities of the sending and receiving nodes involved in the interaction etc. A hash of a block is like a fingerprint that uniquely identifies the block (and the interaction or activity recorded by the block) within the blockchain. Each hash of a block is generated based on a cryptographic hash algorithm.

In one embodiment, one or both of the user device 104 or user device 106 is part of the blockchain network 120.

It may be noted that each of the computing nodes 122 may be implemented like the virtual-world server 150 shown in FIG. 1. For example, each of the computing nodes 122 may have a respective processor and a memory that stores data and instructions to perform a respective functionality of the computing node 122.

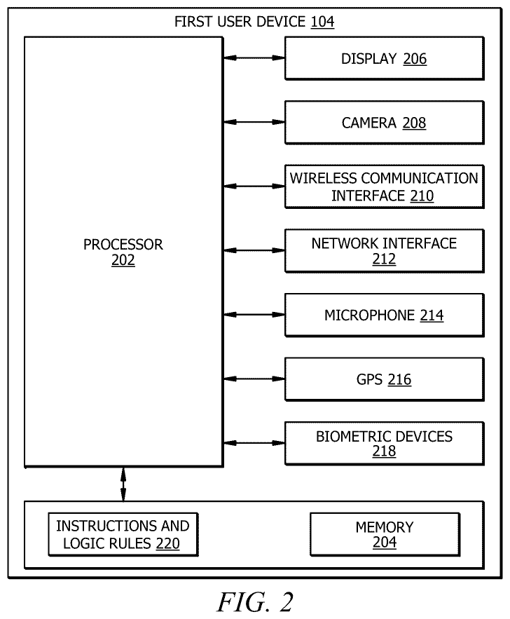

Each of the user devices (i.e., first user device 104 and second user device 106) may be any computing device configured to communicate with other devices, such as a server (e.g., virtual-world server 150), computing nodes 122 of the blockchain network 120, databases, etc. through the communication network 190. Each of the user devices may be configured to perform specific functions described herein and interact with the virtual-world server 150, e.g., via respective user interfaces. Each of the user devices is a hardware device that is generally configured to provide hardware and software resources to a user. Examples of a user device include, but are not limited to, a virtual reality (VR) device (VR headset), an augmented reality device, a laptop, a computer, a smartphone, a tablet, a smart device, an Internet-of-Things (IoT) device, or any other suitable type of device. The user devices may comprise a graphical user interface (e.g., a display), a touchscreen, a touchpad, keys, buttons, a mouse, or any other suitable type of hardware that allows a user to view data and/or to provide inputs into the user device. Each user device may be configured to allow a user to send requests to the virtual-world server 150, or to another user device. In one embodiment, the virtual-world server 150 may be configured to render at least a portion of the virtual environment 102 for display on the user device (e.g., 104, 106) of a user (e.g., first user 110, second user 112). Rendering the virtual environment 102 may include rendering one or more UI elements 164 associated with the virtual environment for display on a display 206 (shown in FIG. 2) of the user device (e.g., 104, 106).

### Example User Device

FIG. 2 is a block diagram of an embodiment of the first user device 104 used by the system of FIG. 1. First user device 104 may be configured to display the virtual environment 102 (referring to FIG. 1) within a field of view 166 of the first user 110 (referring to FIG. 1), capture biometric, sensory, and/or physical information of the first user 110 wearing the first user device 104, and to facilitate an electronic interaction between the first user 110 and the second user 112 (referring to FIG. 1) or between the first user 110 and an entity in the virtual environment 102.

First user device 104 comprises a processor 202, a memory 204, and a display 206. Further embodiments may include a camera 208, a wireless communication interface 210, a network interface 212, a microphone 214, a global position system (GPS) sensor 216, and/or one or more biometric devices 218. First user device 104 may be configured as shown or in any other suitable configuration. For example, first user device 104 may comprise one or more additional components (e.g., input devices such as mouse, joystick, data glove, haptic input device, etc.) and/or one or more shown components may be omitted.

The processor 202 comprises one or more processors operably coupled to and in signal communication with memory 204, display 206, camera 208, wireless communication interface 210, network interface 212, microphone 214, GPS sensor 216, and biometric devices 218. Processor 202 is configured to receive and transmit electrical signals among one or more of memory 204, display 206, camera 208, wireless communication interface 210, network interface 212, microphone 214, GPS sensor 216, and biometric devices 218. The electrical signals are used to send and receive data (e.g., images captured from camera 208, virtual objects (e.g., UI elements 164) to display on display 206, etc.) and/or to control or communicate with other devices. Processor 202 may be operably coupled to one or more other devices (for example, virtual-world server 150 shown in FIG. 1).

The processor 202 is any electronic circuitry including, but not limited to, state machines, one or more central processing unit (CPU) chips, logic units, cores (e.g., a multi-core processor), field-programmable gate array (FPGAs), application specific integrated circuits (ASICs), or digital signal processors (DSPs). The processor 202 may be a programmable logic device, a microcontroller, a microprocessor, or any suitable combination of the preceding. The one or more processors are configured to process data and may be implemented in hardware or software. For example, the processor 202 may be 8-bit, 16-bit, 32-bit, 64-bit or of any other suitable architecture. The processor 202 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components.

The one or more processors are configured to implement various instructions. For example, the one or more processors are configured to execute instructions to implement the function disclosed herein, such as some or all of those described with respect to FIGS. 1 and 3. For example, processor 202 may be configured to display virtual objects (e.g., UI elements 164) on display 206, detect hand gestures, identify virtual objects selected by a detected hand gesture, capture biometric information of a user, such as first user 110, via one or more of camera 208, microphone 214, and/or biometric devices 218, and communicate via wireless communication interface 210 with the virtual-world server 150 and/or second user device 106. In some embodiments, the function described herein is implemented using logic units, FPGAs, ASICs, DSPs, or any other suitable hardware or electronic circuitry.

The memory 204 is operable to store any of the information described with respect to FIGS. 1 and 3 along with any other data, instructions, logic, rules, or code operable to implement the function(s) described herein when executed by processor 202. For example, the memory 204 may store the instructions 220. The memory 204 comprises one or more disks, tape drives, or solid-state drives, and may be used as an over-flow data storage device, to store programs when such programs are selected for execution, and to store instructions and data that are read during program execution. Memory 204 is operable to store, for example, information relating to the identity of the user (e.g., at least a portion of user profile 162), instructions for performing the functions of first user device 104 described herein, and any other data or instructions. The memory 204 may be volatile or non-volatile and may comprise read-only memory (ROM), random-access memory (RAM), ternary content-addressable memory (TCAM), dynamic random-access memory (DRAM), and static random-access memory (SRAM).

Display 206 is configured to present visual information (e.g., UI elements 164) to a user (for example, first user 110 in FIG. 1) in a virtual reality environment, an augmented reality environment or mixed reality environment. In other embodiments, the display 206 is configured to present visual information to the user as the virtual environment 102 (referring to FIG. 1) in real-time. In an embodiment, display 206 is a wearable optical display (e.g., glasses or a headset) configured to reflect projected images and enables a user to see through the display. For example, display 206 may comprise display units, lens, semi-transparent mirrors embedded in an eye glass structure, a visor structure, or a helmet structure. Examples of display units include, but are not limited to, a cathode ray tube (CRT) display, a liquid crystal display (LCD), a liquid crystal on silicon (LCOS) display, a light emitting diode (LED) display, an active-matrix OLED (AMOLED), an organic LED (OLED) display, a projector display, or any other suitable type of display as would be appreciated by one of ordinary skill in the art upon viewing this disclosure. In another embodiment, display 206 is a graphical display on a user device. For example, the graphical display may be the display of a tablet or smart phone configured to display virtual environment 102.

Examples of camera 208 include, but are not limited to, charge-coupled device (CCD) cameras and complementary metal-oxide semiconductor (CMOS) cameras. Camera 208 is configured to capture images of a wearer of first user device 104, such as first user 110. Camera 208 may be configured to capture images continuously, at predetermined intervals, or on-demand. For example, camera 208 may be configured to receive a command from first user 110 to capture an image. In another example, camera 208 is configured to continuously capture images to form a video stream. Camera 208 is communicably coupled to processor 202.

Examples of wireless communication interface 210 include, but are not limited to, a Bluetooth interface, an RFID interface, a near field communication interface, a local area network (LAN) interface, a personal area network interface, a wide area network (WAN) interface, a Wi-Fi interface, a ZigBee interface, or any other suitable wireless communication interface as would be appreciated by one of ordinary skill in the art upon viewing this disclosure. Wireless communication interface 210 is configured to facilitate processor 202 in communicating with other devices. For example, wireless communication interface 210 is configured to enable processor 202 to send and receive signals with other devices, such as second user device 106, the virtual-world server 150, and/or computing nodes 122 of the blockchain network 120 (referring to FIG. 1). Wireless communication interface 210 is configured to employ any suitable communication protocol.

The network interface 212 is configured to enable wired and/or wireless communications. The network interface 212 is configured to communicate data between the first user device 104 and other network devices, systems, or domain(s). For example, the network interface 212 may comprise a WIFI interface, a local area network (LAN) interface, a wide area network (WAN) interface, a modem, a switch, or a router. The processor 202 is configured to send and receive data using the network interface 212. The network interface 212 may be configured to use any suitable type of communication protocol as would be appreciated by one of ordinary skill in the art.

Microphone 214 is configured to capture audio signals (e.g., voice signals or commands) from a user, such as first user 110. Microphone 214 is configured to capture audio signals continuously, at predetermined intervals, or on-demand. Microphone 214 is communicably coupled to processor 202.

GPS sensor 216 is configured to capture and to provide geographical location information. For example, GPS sensor 216 is configured to provide a geographic location of a user, such as first user 110, employing first user device 104. GPS sensor 216 may be configured to provide the geographic location information as a relative geographic location or an absolute geographic location. GPS sensor 216 may provide the geographic location information using geographic coordinates (i.e., longitude and latitude) or any other suitable coordinate system. GPS sensor 216 is communicably coupled to processor 202.

Examples of biometric devices 218 may include, but are not limited to, retina scanners, fingerprint scanners and facial scanners. Biometric devices 218 are configured to capture information about a person's physical characteristics and to output a biometric signal based on captured information. A biometric signal is a signal that is uniquely linked to a person based on their physical characteristics. For example, biometric device 218 may be configured to perform a retinal scan of the user's eye and to generate a biometric signal for the user based on the retinal scan. As another example, a biometric device 218 is configured to perform a fingerprint scan of the user's finger and to generate a biometric signal for the user based on the fingerprint scan. Biometric device 218 is communicably coupled to processor 202.

It may be noted that the second user device 106 (shown in FIG. 1) associated with the second user 112 may be implemented like the first user device 104 shown in FIG. 2. For example, the second user device 106 may have a respective processor and a memory that stores data and instructions to perform a respective functionality of the second user device 106. Additionally, or alternatively, like the first user device 104, the second user device 106 may include one or more of the components shown in FIG. 2 including display, camera, wireless communication interface, network interface, microphone, GPS, or biometric devices.

Referring back to FIG. 1, in one or more embodiments, one or both of the virtual-world server 150 and the blockchain network 120 may be part of an Information Technology (IT) infrastructure of an entity or organization.

The virtual-world server 150 may be configured to allow users (e.g., first user 110) registered with the virtual-world server 150 to perform one or more data interactions in the virtual environment 102 (e.g., a metaverse environment). When the virtual-world server 150 is owned and/or operated by a particular entity or organization (e.g., is part of the IT infrastructure of the entity or organization), being registered with the virtual-world server 150 may also be interpreted as being registered with the particular entity or organization. For example, when the first user 110 is registered with the virtual-world server 150, this may be interpreted as the first user 110 being registered with the entity or organization that owns and/or manages the virtual world server 150.

The first user 110 may register with the virtual-world server 150. In one embodiment, when initially registering with the virtual-world server 150, the first user 110 may provide to the virtual-world server 150 a user credential 160 (e.g., username and password) that provides the first user 110 access to the virtual-world server 150. For example, registration with the virtual-world server 150 may include generating a user credential 160 that allows the first user 110 to log in to the virtual-world server 150 and enter the virtual environment 102 via first avatar 114 of the first user 110. Once registered with the virtual-world server 150, the first user 110 may generate a virtual data file (not shown) in which the first user 110 may store virtual data objects owned by the first user 110. Information relating to the virtual data file of the first user 110 may be stored by the virtual-world server 150 as part of the user profile 162 of the first user 110 stored at the virtual-world server 150. This information may include, but is not limited to, an identity of the virtual data file, amount of virtual data objects stored in the virtual data file, a log of virtual data interactions conducted in the virtual environment 102 in relation to the virtual data file and any other information relating to the virtual data file.

In one embodiment, as the first user 110 registers with the virtual-world server 150, the virtual-world server 150 may collect several pieces of information from the first user 110 including information relating to the identity of the user such as legal name, social security number, biometrics (e.g., fingerprints, retina scans, face ID etc.), residence address, phone numbers, assets owned by the user, and copies of government issued documents (e.g., drivers permit, state identity card etc.). This information is stored by virtual-world server 150 as part of user profile 162 (e.g., first user profile 162a) of the first user 110. Once the identity of the first user 110 is confirmed and all other information provided by the first user 110 is verified to be correct, the virtual-world server 150 may generate the virtual data file for the first user 110 in which the first user 110 may store virtual data objects owned by the first user 110.

Once registered with the virtual-world server 150, the virtual-world server 150 may allow the first user 110 to perform one or more virtual data interactions. For example, a virtual data interaction may include transferring one or more virtual data objects from the virtual data file of the first user 110 to a second virtual data file of the second user 112 or another entity. Another example data interaction may include receiving one or more virtual data objects in the virtual data file of the first user 110 from a second virtual data file of the second user 112 or another entity. Another example data interaction may include requesting by the first user 110 transfer of virtual data objects from a data file of a second user to a data file of a third user as part of satisfying an agreement between the first user 110 and the third user. Another example data interaction may include modifying at least a portion of the user profile 162 (e.g., user credentials to access the virtual-world server 150, phone numbers, residential address, email address, information relating to user assets etc.) stored at the virtual-world server 150.

### Dynamic User Interface for a Virtual Environment

As described above, the virtual environment 102 may include a plurality of UI elements 164 that are rendered and displayed on a first user device 104 of a first user 110 as the first user 110 navigates the virtual environment 102. The UI elements 164 configured to be presented/displayed in the virtual environment 102 may include, but are not limited to, a graphical or virtual representation of a metaverse, a map, a building interior, a landscape, a fictional location, an alternate reality, or any other suitable type of location or environment. In alternative or additional embodiments, the virtual environment 102 may include one or more UI elements 164 that allow a user (e.g., first user 110) to perform one or more data interactions within the virtual environment 102. For example, the virtual environment 102 may include UI elements 164 including, but not limited to, forms, menus, widgets, buttons, links, fields, and/or any other input controls, navigational components, information components and content containers.

Presently, a virtual environment (e.g., virtual environment 102 such as a metaverse environment) is configured to present/display to a user (e.g., first user 110) all or most UI elements 164 that are configured in the field of view 166 of the user within the virtual environment regardless of whether a UI element 164 is relevant to the user or whether the user is authorized to view/access a UI element 164. For example, the first user 110 may enter the virtual environment 102 to access and play virtual reality games. In this example, UI elements 164 that relate to shopping merchandise (e.g., clothes, shoes, etc.) such as virtual stores are irrelevant to the first user 110. In another example, the first user 110 may not be authorized to view/access certain products or services in the virtual environment 102. For example, an underage user may not have authorization to access UI elements 164 such as virtual stores selling alcohol, tobacco products, or adult entertainment. In another example, the first user 110 may not have authorization to view certain sensitive information/data in the virtual environment such as UI elements 164 including personal data associated with other users (e.g., second user). In another example, the first user 110 may not have access to certain UI elements 164 such as virtual spaces (e.g., virtual sub-environments representing private spaces within the virtual environment 102) within the virtual environment 102. Present virtual environments 102 are typically configured to present/display to the first user 110 all or most UI elements 164 that are configured in the field of view 166 of the first user 110 within the virtual environment 102 without any consideration of whether certain UI elements 164 presented/shown to the first user 110 are relevant to the first user 110, or whether the first user 110 is authorized to view/access certain UI element 164.

Rendering all or most UI elements 164 of the virtual environment 102 for each user that enters the virtual environment 102 needs a large amount of computational resources and network resources. For example, a processing server will need to process and render all UI elements 164 for display on each user device that is being used to view/access the virtual environment 102. Since, each user may have a different field of view within the virtual environment 102, the processing server may need to separately process all UI elements 164 that are in the respective fields of view of each user. Further, as a user changes the field of view within the virtual environment 102, the processing server will need to process and render all UI elements 164 that are within the user's new field of view. Additionally, a large amount of network bandwidth is used to transmit large data files related to the rendered virtual environment 102 over the network to each user device. Also, by rendering and displaying UI elements 164 that a user may not be authorized to view or access, the present systems may compromise data security of the virtual environment 102 and may unintentionally facilitate data theft.

Embodiments of the present disclosure describe techniques for generating a virtual environment 102 that dynamically adapts UI elements 164 presented/displayed within the virtual environment 102 based on a user profile 162 of a user (e.g., first user 110) navigating the virtual environment 102. For example, as described in more detail below, a user profile 162 (e.g., first user profile 162a) associated with a user (e.g., first user 110) may include a set of UI elements (e.g., UI elements 164a) that the user is authorized to view/access and/or is relevant to the user. As the user navigates the virtual environment 102, the virtual-world server 150 renders only those UI elements (e.g., UI elements 164a or a portion thereof) for display to the user device (e.g., first user device 104) that are associated with the user profile of the user and does not render UI elements 164 that are not associated with the user profile of the user.

By processing and rendering only those UI elements 164 that are associated with the user profile of the viewing user, the virtual-world server 150 may process and render only a portion of the overall UI elements 164 that are configured for the virtual environment 102. Processing and rendering a smaller number of UI elements 164 saves computing resources (e.g., processing and memory resources) of the virtual-world server 150. This improves the processing efficiency of the virtual-world server 150. Further, since a smaller number of UI elements 164 are rendered, the data files (including rendered images/frames of the virtual environment 102) transmitted by the virtual-world server 150 to the user device of the user are also smaller, thus using lesser network bandwidth. This improves the network efficiency of the network 190 used to transmit these data files to the user device. Accordingly, the system shown in FIG. 1 and described in embodiments of the present disclosure improves computing technology and networking technology.

As described above, the virtual-world server 150 may store a user profile 162 for each user (e.g., first user 110, second user 112) that is registered to access the virtual environment 102. For example, as shown in FIG. 1, the virtual-world server 150 stores a first user profile 162a associated with the first user 110 and second user profile 162b associated with the second user 112. A user profile 162 associated with a user (e.g., first user 110, second user) may include a set of UI elements 164 that the user is authorized to view/access and/or is relevant to the user within the virtual environment 102. For example, as shown in FIG. 1, the first user profile 162a includes a first set of UI elements 164a that the first user 110 is authorized to view/access in the virtual environment 102 and/or is relevant to the first user 110. Similarly, the second user profile 162b includes a second set of UI elements 164b that the second user 112 is authorized to view/access in the virtual environment 102 and/or is relevant to the second user 112.

In one or more embodiments, each UI element 164 configured for the virtual environment 102 is uniquely identified by a non-fungible token (NFT) 130. For example, as shown in FIG. 1, NFTs 130a, 130b, and 130n are associated with and uniquely identify UI elements 164-1, 164-2 and 164-n respectively. In one embodiment, once a new UI element 164 is added to the virtual environment 102, the virtual-world server 150 may be configured to generate an NFT 130 associated with the new UI element 164, wherein the NFT 130 uniquely identifies the UI element 164. The virtual-world server 150 may use an NFT minting node (not shown) to generate NFTs 130 associated with respective UI elements 164. In one embodiment, the NFT minting node may be a computing node 122 of the blockchain network 120.

An NFT 130 is a blockchain based digital certificate that uniquely identifies a digital asset (e.g., a UI element 164) and thus acts as verifiable proof of ownership of the digital asset. An NFT 130 may be generated for a particular digital asset e.g., a UI element 164) and includes information relating to the digital asset, and further includes a unique digital signature that cannot be changed as NFTs 130 are stored in a distributed network such as the blockchain network 120. Using a native digital signature scheme on the blockchain network 120, it is easy to verify the authenticity of each NFT 130, its identity, its unique attributes, and its owner. Since NFTs 130 cannot be modified easily, this greatly reduces the possibility of bad actors tampering with the NFT 130. In one embodiment, the virtual-world server 150 may leverage NFT technology to avoid unauthorized access to UI elements 164 within the virtual environment and/or to track down any malicious activity that has been performed in the virtual environment 102 in relation to a UI element 164. For example, the virtual-world server 150 may record information relating to data interactions performed in relation to UI elements 164 in the blockchain network 120 (e.g., as part of the blockchain ledger). Since each UI element 164 is uniquely identified by a respective NFT 130, a data interaction relating to a particular UI element 164 may be recorded against the respective NFT 130 in a verifiable and immutable manner, thus avoiding tampering with the history of the data interactions associated with the particular UI element 164 by a malicious entity.

An NFT 130 may be generated through a process called minting. Minting is a process that involves signing a blockchain transaction in the blockchain network 120 that outlines the fundamental token details, which is then broadcasted to the blockchain network 120 to trigger a smart contract function which creates the token and assigns it to its owner (e.g., user/entity associated with the UI element 164). This minting process may be performed by an NFT minting node which may be a minting server of the blockchain network 120. An NFT 130 generated by the blockchain network 120 (e.g., by the NFT minting node) generally includes a unique token ID of the NFT 130 and other information related to the digital asset (e.g., UI element 164) identified by the NFT 130.

In one or more embodiments, once a new UI element 164 has been added to the virtual environment 102, the virtual-world server 150 may be configured to request the NFT minting node to generate a unique NFT 130 associated with the new UI element 164. Generating the NFT 130 by the NFT minting node may include generating the NFT 130 identified by a unique token ID and associating the unique token ID of the NFT 130 to the new UI element. In one embodiment, the NFT 130 may store a copy of the new UI element 164 or a link to the UI element 164 stored in the blockchain network 120 (e.g., stored on a computing node 122 of the blockchain network 120).

In one embodiment, a user profile 162 associated with a user (e.g., first user 110, second user 112) stores NFTs 130 of each UI element 164 the user is authorized to view/access or is relevant to the user. For example, the first user profile 162 stores NFTs 130 associated with each UI element 164 in the first set of UI elements 164a. In one embodiment, a user profile 162 associated with a user (e.g., first user 110, second user 112) stores NFTs 130 instead of or in addition to the UI elements 164 associated to the user profile 162.

Virtual-world server 150 may be configured to use a user credential 160 collected from a user (e.g., first user 110, second user 112), generated by the user or assigned to the user during, to verify identity of the user in the virtual environment 102. In this context, the virtual-world server 150 stores a user credential 160 associated with each user (e.g., first user 110, second user 112) who is authorized to access the virtual environment 102. For example, as shown in FIG. 1, the virtual-world server 150 stores a first user credential 160a associated with the first user 110 and stores a second user credential 160b associated with the second user 112. Thus, the user credential 160 provides a user (e.g., first user 110, second user 112) access to the virtual environment 102. In one embodiment, the user credential 160 may be used by the virtual-world server 150 to verify that an avatar (114, 116) belongs to and is controlled by the respective user (e.g., first user 110, second user 112).

For example, a retina scan of the first user 110 may have been previously collected from the first user 110 as part of a real-world data interaction with the first user 110. Information relating to the retina scan may have been stored in the virtual-world server 150 as part of the first user profile 162a. The retina scan of the first user 110 may be used as the first user credential 160a. When the first user 110 uses the first user device 104 (e.g., VR headset) to initiate a first request 142 to enter the virtual environment 102 via first avatar 114, the virtual-world server 150 obtains a retina scan of the first user 110 using a biometric device (e.g., biometric device 218) provided at the first user device 104. The retina scan obtained via the first user device 104 is compared with the retina scan of the first user 110 stored as part of first user profile 162a in the virtual-world server 150. When the two retina scans match, virtual-world server 150 determines that the first avatar 114 is associated with the first user 110 and may authorize and allow the first avatar 114 to enter the virtual environment 102.

In another example, the first user credential 160a may include in the first request 142 a username and password generated by the first user 110 as part of registering with the virtual-world server 150. The virtual-world server 150 may allow the first user 110 to use the username and password to enter the virtual environment 102 via first avatar 114.

As described above, the virtual-world server 150 may be configured to generate and implement a dynamic user interface for the virtual environment 102 that adapts, in real-time, UI elements 164 presented/displayed within the virtual environment 102 based on user profiles 162 associated with users (e.g., first user 110, second user 112) that have accessed the virtual environment 102. For example, once the first user 110 has accessed the virtual environment 102 or a portion thereof (e.g., the first avatar 114 of the first user 110 has entered the virtual environment 102) using the first user device 104, the virtual-world server 150 accesses the first user profile 162a of the first user 110. In one embodiment, the first user profile 162a of the first user 110 may be associated with or mapped to the first user credential 160a of the first user 110 that the first user 110 used to access the virtual environment 102. In this case, the virtual-world server 150 may access from the memory 156, the first user profile 162a that is associated with the first user credential 160a of the first user 110. The virtual-world server 150 then obtains the first set of UI elements 164a (or associated NFTs 130) associated with the first user profile 162a (e.g., stored as part of the first user profile 162a). In this case, the first set of UI elements 164a represents a portion of the UI elements 164 that are configured for the virtual environment 102, wherein the first set of UI elements 164a is the portion of the UI elements 164 the first user 110 is authorized to view/access and/or is relevant to the first user 110 within the virtual environment 102. The virtual-world server 150 may be configured to render the first set of UI elements 164a or a portion thereof for display on the first user device 104 of the first user 110.

In some cases, the virtual environment 102 or a portion there of (e.g., a virtual sub-environment within the virtual environment 102) may be shared by multiple users (e.g., first user 110, second user 112) at the same time. For example, multiple users may have accessed the virtual environment 102 or a portion thereof and may be navigating the virtual environment 102 or the portion thereof in conjunction with each other. In present systems, each user navigating a virtual environment in conjunction is presented/views and/or has access to the same UI elements 164 that are configured for the virtual environment. However, in one or more embodiments of the present disclosure, when the virtual environment 102 or a portion thereof (e.g., a virtual sub-environment within the virtual environment 102) is shared by multiple users (e.g., multiple users are navigating the virtual environment 102 in conjunction), the virtual-world server 150 may be configured to present/display to each user within the shared virtual environment 102 only those UI elements 164 that are associated with the respective user profile 162 of the user. In other words, each user within a shared virtual environment 102 views and/or has access to only those UI elements 164 that the user is authorized to view/access and/or are relevant to the user.

For example, the second user 112 may enter the virtual environment 102 or a same portion of the virtual environment 102 that the first user 110 is present in or is navigating. For example, like the first user 110, the second user 112 may initiate a second request 144 to enter the virtual environment 102 and provide the second user credential 160b associated with the second user 112 as part of the second request 144. After verifying the second user credential 160b, the virtual-world server 150 may allow the second user 110 to enter the virtual environment 102 via the second avatar 116. In one embodiment, after entering the virtual environment 102, the second user 112 may navigate to the same portion of the virtual environment 102 that the first user 110 present in or is navigating. This means that the first user 110a and the second user 112 are navigating the same virtual environment 102 or a portion thereof at the same time. However, the first user 110 and the second user 112 may be presented different sets of UI elements 164 depending on their respective user profiles 162a. For example, as described above, the first user 110 is presented the first set of UI elements 164a that are associated with the first user profile 162 of the first user 110. Similarly, once the second user 112 has accessed the virtual environment 102 or the portion thereof (e.g., the second avatar 116 of the second user 112 has entered the virtual environment 102) using the second user device 106, the virtual-world server 150 accesses the second user profile 162b of the second user 112. In one embodiment, the second user profile 162b of the second user 112 may be associated with or mapped to the second user credential 160b of the second user 112 that the second user 112 used to access the virtual environment 102. In this case, the virtual-world server 150 may access from the memory 156, the second user profile 162b that is associated with the second user credential 160b of the second user 112. The virtual-world server 150 then obtains the second set of UI elements 164b (or associated NFTs 130) associated with the second user profile 162b (e.g., stored as part of the second user profile 162b). In this case, the second set of UI elements 164b represents a portion of the UI elements 164 that are configured for the virtual environment 102 or the portion thereof, wherein the second set of UI elements 164b is the portion of the UI elements 164 the second user 112 is authorized to view/access and/or is relevant to the second user 112 within the virtual environment 102. The virtual-world server 150 may be configured to render the second set of UI elements 164b or a portion thereof for display on the second user device 106 of the second user 112. Thus, while the first user 110 and the second user 112 are present in or navigating the same virtual environment 102 or potion thereof configured with the same UI elements 164, each of the first user 110 and the second user 112 view/access different portions of the UI elements 164 based on their respective user profiles (e.g., first user profile 162a, second user profile 162b).

In one or more embodiments, the virtual-world server 150 may be configured to selectively render UI elements 164 based on the field of view 166 of the user (e.g., first user 110, second user 112) within the virtual environment 102. The term “field of view” refers to an amount of the observable virtual environment 102 that a user can view at any one point in time using a user device (e.g., VR headset). Thus, any one point, one a portion of UI elements 164 configured for the virtual environment 102 may be positioned in the field of view 166 of a user (e.g., first user 110, second user 112). Further, out of the UI elements 164 that are within the field of view 166 of the user, only a subset of those UI elements 164 may be included in the user profile 162 of the user. The virtual-world server 150 may be configured to render only a portion of UI elements 164 that are in the field of view 166 of the user, wherein the portion of the UI elements are included in the user profile 162 of the user. For example, the virtual-world server 150 may be configured to determine a current field of view 166 of the first user 110 based on one or more of a plurality of sensors and/or input devices associated with the first user device 104 of the first user 110. For example, the first user device 104 may include sensors that can track eye-ball movements and head movements of the first user 110. The virtual-world server 150 may be configured to determine a field of view 166 of the first user 110 within the virtual environment 102 based data received from the first user device 104 relating to one or a combination of the eye-ball movements or head movements of the first user 110. In an additional or alternative embodiment, the first user device 104 may include input devices such as mouse, joystick, data glove, haptic input device which the first user 110 may use to change the field of view 166 within the virtual environment 102. The virtual-world server 150 may be configured to determine a current field of view 166 of the first user 110 based on one or more of the sensors and input devices associated with the first user device 104.

Once the field of view 166 of the first user 110 has been determined, the virtual-world server obtains a list of UI elements 164 that are positioned within the field of view 166 of the first user 110. For each UI element 164 that is positioned within the field of view of the first user 110, the virtual-world server 150 determines whether the UI element 164 is part of the UI elements 164a listed in first user profile 162a of the first user 110. By this process, the virtual-world server 150 determines a subset of UI elements 164 positioned in the field of view 166 of the first user 110 that are part of the first user profile 162a of the first user 110. The virtual-world server 150 then renders only the subset of UI elements 164 for display on the first user device 104 within the field of view 166 of the first user 110.

In one or more embodiments, as the field of view 166 of the first user 110 changes within the virtual environment 102, the virtual-world server 150 may be configured to dynamically repeat the above described process in real time to determine a new subset of UI elements 164 associated with the first user profile 162a that are included in the current field of view 166 of the first user 110 and render the new subset of UI elements 164 for display on the first user device 104 of the first user 110. For example, based on one or more of the sensors or input devices associated with the first user device 104, the virtual-world server 150 may detect that the first user 110 has switched from a first field of view 166 to a second field of view 166 within the virtual environment 102. Once the new second field of view 166 has been determined, the virtual-world server 150 obtains a list of UI elements 164 that are positioned within the second field of view 166 of the first user 110. For each UI element 164 that is positioned within the second field of view of the first user 110, the virtual-world server 150 determines whether the UI element 164 is part of the UI elements 164a listed in first user profile 162a of the first user 110. By this process, the virtual-world server 150 determines a second subset of UI elements 164 positioned in the second field of view 166 of the first user 110 that are part of the first user profile 162a of the first user 110. The virtual-world server 150 then renders only the second subset of UI elements 164 for display on the first user device 104 within the second field of view 166 of the first user 110.

In one or more embodiments, the virtual-world server 150 may be configured to allow a user (e.g., first user 110) to configure the UI elements 164 included in the user profile 162 of one or more other users (e.g., second user 112). Configuring the UI elements 164 included in a user profile 162 may include adding one or more new UI elements 164 to the user profile 162, deleting one or more UI elements from the user profile 162, or a combination thereof. For example, the first user 110 may be an administrator of the second user profile 162b. To configure the second set of UI elements 164B included in the second user profile 162b of the second user 112, the first user 110 use the first user device 104 to initiate a configuration request 168, wherein the configuration request 168 may include a request to add one or more new UI elements 164 to the second user profile 162b, delete one or more UI elements 164 from the second user profile 162b, or a combination thereof. In response to receiving the configuration request 168 from the first user 110, the virtual-world server 150 may verify the authorization of the first user 110 to perform the requested change in configuration of the second user profile 162B. For example, the first user 110 may only add those UI elements 164 to the second set of UI elements 164B that are already part of the first set of UI elements 164a in the first user profile 162a of the first user 110. Thus, when the configuration request 168 includes addition of one or more UI elements 164 to the second set of UI elements 164b, the virtual-world server 150 checks whether the one or more UI elements 164 are part of the first set of UI elements 164a in the first user profile 162a of the first user 110. In response to successfully verifying that the one or more UI elements 164 are part of the first set of UI elements 164a in the first user profile 162a of the first user 110, the virtual-world server 150 may add the one or more requested UI elements 164 to the second set of UI elements 164B associated with the second user profile 162B of the second user 112. Once, the one or more UI elements 164 are added to the second user profile 162b, the virtual-world server 150 may render the one or more UI elements 164 for display on the second user device 106 of the second user 112. Similarly, the first user 110 may delete one or more UI elements 164 from the second user profile 162b of the second user 112 which would stop the virtual-world server 150 from rendering those one or more UI elements 164 for display on the second user device 106 of the second user 112. In one or more embodiments, the first user 110 may temporarily add and/or delete one or more UI elements 164 from the second user profile 162b of the second user 112. For example, the configuration request 168 may specify a time period within which the new configuration is to apply. This allows the first user 110 to temporarily provide access to one or more UI elements 164 to the second user 112 and/or temporarily pull access of one or more UI elements 164 from the second user 112.

In one or more embodiments, the virtual-world server 150 may be configured to allow the first user 110 to share a data interaction session within the virtual environment 102 with the second user 112. Sharing a data interaction session allows the second user 112 to view all UI elements 164 viewed/accessed by the first user and each action/operation performed by the first user 110 relating to the UI elements 164 until the shared data interaction session is terminated. For example, a software architect may temporarily share a data interaction session with a software programmer to demonstrate configuration of a production software environment. In another example, a child may share a data interaction session with a parent to show the parent an error that occurs while performing an operation. For example, to share a data interaction session with the second user 112, the first user 110 may initiate an interaction share request 170. In response to detecting the interaction share request 170 initiated by the first user 110, the virtual-world server 150 adds to the second user profile 162b in real-time all UI elements 164 that are in the field of view 166 of the first user 110 within the virtual environment 102. This allows the virtual-world server 150 to render the field of view 166 of the first user 110 for display on the second user device 106 of the second user 112, which includes rendering each UI element 164 in the field of view 166 of the first user 110 for display on the second user device 106. In one embodiment, by adding to the second user profile 162b all UI elements 164 that are in the field of view 166 of the first user 110 within the virtual environment 102, the second user 112 may view/access even those UI elements 164 from the field of view 166 that are otherwise not part of the second user profile 162b of the second user 112. In one embodiment, as the field of view 166 of the first user 110 changes within the virtual environment 102, the virtual-world server 150 may dynamically and in real-time add to the second user profile 162b a new set of UI elements 164 associated with the new field of view 166 of the first user 110 and render the new filed of view 166 for display on the second user device 106. In one embodiment, in response to receiving a request to terminate the shared data interaction request from the first user device 104, the virtual-world server 150 may stop rendering the field of view 166 of the first user 110 for display on the second user device 106 and further delete all those UI elements 164 from the second user profile 162b that were added to the second user profile 162b as part of sharing the data interaction.

FIG. 3 illustrates a flowchart of an example method 300 for generating a dynamic virtual environment 102, in accordance with one or more embodiments of the present disclosure. Method 300 may be performed by the virtual-world server 150 shown in FIG. 1.

At operation 302, virtual-world server 150 receives a first request 142 from a first user device 104 associated with a first user 110 to enter the virtual environment 102, wherein the first request 142 includes a first user credential 160a that allows the first user 110 access to the virtual environment 102.

At operation 304, virtual-world server 150 authorizes, based on the first user credential 160a, a first avatar 114 of the first user 110 to enter the virtual environment 102.

As described above, virtual-world server 150 may be configured to use a user credential 160 collected from a user (e.g., first user 110, second user 112), generated by the user or assigned to the user during, to verify identity of the user in the virtual environment 102. In this context, the virtual-world server 150 stores a user credential 160 associated with each user (e.g., first user 110, second user 112) who is authorized to access the virtual environment 102. For example, as shown in FIG. 1, the virtual-world server 150 stores a first user credential 160a associated with the first user 110 and stores a second user credential 160b associated with the second user 112. Thus, the user credential 160 provides a user (e.g., first user 110, second user 112) access to the virtual environment 102. In one embodiment, the user credential 160 may be used by the virtual-world server 150 to verify that an avatar (114, 116) belongs to and is controlled by the respective user (e.g., first user 110, second user 112).

For example, a retina scan of the first user 110 may have been previously collected from the first user 110 as part of a real-world data interaction with the first user 110. Information relating to the retina scan may have been stored in the virtual-world server 150 as part of the first user profile 162a. The retina scan of the first user 110 may be used as the first user credential 160a. When the first user 110 uses the first user device 104 (e.g., VR headset) to initiate a first request 142 to enter the virtual environment 102 via first avatar 114, the virtual-world server 150 obtains a retina scan of the first user 110 using a biometric device (e.g., biometric device 218) provided at the first user device 104. The retina scan obtained via the first user device 104 is compared with the retina scan of the first user 110 stored as part of first user profile 162a in the virtual-world server 150. When the two retina scans match, virtual-world server 150 determines that the first avatar 114 is associated with the first user 110 and may authorize and allow the first avatar 114 to enter the virtual environment 102.

In another example, the first user credential 160a may include in the first request 142 a username and password generated by the first user 110 as part of registering with the virtual-world server 150. The virtual-world server 150 may allow the first user 110 to use the username and password to enter the virtual environment 102 via first avatar 114.

At operation 306, virtual-world server 150 obtains, based on the first user credential 160a, a first user profile 162a associated with the first user 110.

At operation 308, virtual-world server 150 determines a first set (e.g., UI elements 164a) of the plurality of UI elements 164 associated with the first user profile 162a of the first user 110.

At operation 310, virtual-world server 150 renders the virtual environment 102 for display on the first user device 104 of the first user 110 including one or more UI elements 164 of the first set (e.g., UI elements 164a) of the UI elements 164.

As described above, the virtual-world server 150 may be configured to generate and implement a dynamic user interface for the virtual environment 102 that adapts, in real-time, UI elements 164 presented/displayed within the virtual environment 102 based on user profiles 162 associated with users (e.g., first user 110, second user 112) that have accessed the virtual environment 102. For example, once the first user 110 has accessed the virtual environment 102 or a portion thereof (e.g., the first avatar 114 of the first user 110 has entered the virtual environment 102) using the first user device 104, the virtual-world server 150 accesses the first user profile 162a of the first user 110. In one embodiment, the first user profile 162a of the first user 110 may be associated with or mapped to the first user credential 160a of the first user 110 that the first user 110 used to access the virtual environment 102. In this case, the virtual-world server 150 may access from the memory 156, the first user profile 162a that is associated with the first user credential 160a of the first user 110. The virtual-world server 150 then obtains the first set of UI elements 164a (or associated NFTs 130) associated with the first user profile 162a (e.g., stored as part of the first user profile 162a). In this case, the first set of UI elements 164a represents a portion of the UI elements 164 that are configured for the virtual environment 102, wherein the first set of UI elements 164a is the portion of the UI elements 164 the first user 110 is authorized to view/access and/or is relevant to the first user 110 within the virtual environment 102. The virtual-world server 150 may be configured to render the first set of UI elements 164a or a portion thereof for display on the first user device 104 of the first user 110.

At operation 312, virtual-world server 150 receives a second request 144 from a second user device 106 associated with a second user 112 to enter the virtual environment 102, wherein the second request 144 includes a second user credential 160b that allows the second user 112 to access the virtual environment 102.

At operation 314, virtual-world server 150 authorizes, based on the second user credential 160b, a second avatar 116 of the second user 112 to enter the virtual environment 102.

As described above, in some cases, the virtual environment 102 or a portion thereof (e.g., a virtual sub-environment within the virtual environment 102) may be shared by multiple users (e.g., first user 110, second user 112) at the same time. For example, multiple users may have accessed the virtual environment 102 or a portion thereof and may be navigating the virtual environment 102 or the portion thereof in conjunction with each other. In present systems, each user navigating a virtual environment in conjunction is presented/views and/or has access to the same UI elements 164 that are configured for the virtual environment. However, in one or more embodiments of the present disclosure, when the virtual environment 102 or a portion thereof (e.g., a virtual sub-environment within the virtual environment 102) is shared by multiple users (e.g., multiple users are navigating the virtual environment 102 in conjunction), the virtual-world server 150 may be configured to present/display to each user within the shared virtual environment 102 only those UI elements 164 that are associated with the respective user profile 162 of the user. In other words, each user within a shared virtual environment 102 views and/or has access to only those UI elements 164 that the user is authorized to view/access and/or are relevant to the user.

For example, the second user 112 may enter the virtual environment 102 or a same portion of the virtual environment 102 that the first user 110 is present in or is navigating. For example, like the first user 110, the second user 112 may initiate a second request 144 to enter the virtual environment 102 and provide the second user credential 160b associated with the second user 112 as part of the second request 144. After verifying the second user credential 160b, the virtual-world server 150 may allow the second user 110 to enter the virtual environment 102 via the second avatar 116.

At operation 316, virtual-world server 150 obtains, based on the second user credential 160b, a second user profile 162b associated with the second user 112.

At operation 318, virtual-world server 150 determines a second set (e.g., UI elements 164b) of the plurality of UI elements 164 associated with the second user profile 162b of the second user 112.

At operation 320, virtual-world server 150 renders the virtual environment 102 to display on the second user device 106 of the second user 112 including one or more UI elements 164 of the second set (UI elements 164b) of the UI elements, wherein at least some of the first set (UI elements 164a) of the plurality of UI elements 164 associated with the first user 110 are different from at least some of the second set (UI elements 164b) of the plurality of UI elements 164 associated with the second user 112.

As described above, after entering the virtual environment 102, the second user 112 may navigate to the same portion of the virtual environment 102 that the first user 110 present in or is navigating. This means that the first user 110a and the second user 112 are navigating the same virtual environment 102 or a portion thereof at the same time. However, the first user 110 and the second user 112 may be presented different sets of UI elements 164 depending on their respective user profiles 162a. For example, as described above, the first user 110 is presented the first set of UI elements 164a that are associated with the first user profile 162 of the first user 110. Similarly, once the second user 112 has accessed the virtual environment 102 or the portion thereof (e.g., the second avatar 116 of the second user 112 has entered the virtual environment 102) using the second user device 106, the virtual-world server 150 accesses the second user profile 162b of the second user 112. In one embodiment, the second user profile 162b of the second user 112 may be associated with or mapped to the second user credential 160b of the second user 112 that the second user 112 used to access the virtual environment 102. In this case, the virtual-world server 150 may access from the memory 156, the second user profile 162b that is associated with the second user credential 160b of the second user 112. The virtual-world server 150 then obtains the second set of UI elements 164b (or associated NFTs 130) associated with the second user profile 162b (e.g., stored as part of the second user profile 162b). In this case, the second set of UI elements 164b represents a portion of the UI elements 164 that are configured for the virtual environment 102 or the portion thereof, wherein the second set of UI elements 164b is the portion of the UI elements 164 the second user 112 is authorized to view/access and/or is relevant to the second user 112 within the virtual environment 102. The virtual-world server 150 may be configured to render the second set of UI elements 164b or a portion thereof for display on the second user device 106 of the second user 112. Thus, while the first user 110 and the second user 112 are present in or navigating the same virtual environment 102 or potion thereof configured with the same UI elements 164, each of the first user 110 and the second user 112 view/access different portions of the UI elements 164 based on their respective user profiles (e.g., first user profile 162a, second user profile 162b).

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

To aid the Patent Office, and any readers of any patent issued on this application in interpreting the claims appended hereto, applicants note that they do not intend any of the appended claims to invoke 35 U.S.C. § 112(f) as it exists on the date of filing hereof unless the words “means for” or “step for” are explicitly used in the particular claim.

1. A system comprising:
a memory that stores a user profile associated with each user of a plurality of users that have access to a virtual environment, wherein:
each user profile is associated with at least a set of user interface (UI) elements from among a plurality of UI elements configured to be presented in the virtual environment; and
a user associated with a user profile is authorized to view in the virtual environment only a particular set of the plurality of UI elements that are associated with the user profile; and
a processor communicatively coupled to the memory and configured to:
receive a first request from a first user device associated with a first user to enter the virtual environment, wherein the first request comprises a first user credential that allows the first user access to the virtual environment;
authorize, based on the first user credential, a first avatar of the first user to enter the virtual environment;
obtain, based on the first user credential, a first user profile associated with the first user;
determine a first set of the plurality of UI elements associated with the first user profile of the first user;
render the virtual environment to display on the first user device of the first user including one or more UI elements of the first set of the UI elements;
receive a second request from a second user device associated with a second user to enter the virtual environment, wherein the second request comprises a second user credential that allows the second user to access the virtual environment;
authorize, based on the second user credential, a second avatar of the second user to enter the virtual environment;
obtain, based on the second user credential, a second user profile associated with the second user;
determine a second set of the plurality of UI elements associated with the second user profile of the second user; and
render the virtual environment to display on the second user device of the second user including one or more UI elements of the second set of the UI elements;
wherein at least some of the first set of the plurality of UI elements associated with the first user are different from at least some of the second set of the plurality of UI elements associated with the second user.

2. The system of claim 1, wherein the processor is further configured to:
determine a first field of view of the first user within the virtual environment;
determine a first UI element that is positioned in the first field of view of the user;
determine, based on the first user profile of the first user, whether the first user is authorized to view the first UI element;
in response to determining that the first user is authorized to view the first UI element, render the first UI element for display on the first user device in the first field of view within the virtual environment; and
in response to determining that the first user is not authorized to view the first UI element, do not render the first UI element.

3. The system of claim 2, wherein the processor is further configured to:
detect that the first user has switched from the first field of view to a second field of view within the virtual environment;
in response to detecting that the first user has switched to the second field of view, determine a portion of the plurality of UI elements that are part of the second field of view;
determine, based on the first user profile of the first user, one or more UI elements from the first set of UI elements that are part of the determined portion of the UI elements; and
render the one or more UI elements from the first set of UI elements to display on the first user device in the second field of view within the virtual environment.

4. The system of claim 1, wherein the processor is further configured to:
receive, a third request initiated by the first user from the first user device to provide to the second user access to a particular UI element that the first user is authorized to access but the second user is not authorized to access;
verify, based on the first user profile, that the first user has access to the particular UI element; and
in response to successfully verifying that the first user has access to the particular UI element, render the particular UI element for display on the second user device as part of the virtual environment.

5. The system of claim 1, wherein the processor is further configured to:
receive a configuration request from the first user to configure the second user profile associated with the second user, wherein the configuration request comprises one or more UI elements the second user can access within the virtual environment; and
in response to receiving the configuration request, add the one or more UI elements including the configuration request to the second user profile of the second user.

6. The system of claim 1, wherein each UI element of the plurality of UI elements is uniquely identified by a Non-Fungible Token (NFT) and is stored on one or more computing nodes of a blockchain network.

7. The system of claim 6, wherein the first user profile stores NFTs associated with the first set of UI elements and the second user profile stores NFTs associated with the second set of UI elements.

8. A method comprising:
receiving a first request from a first user device associated with a first user to enter a virtual environment, wherein the first request comprises a first user credential that allows the first user access to the virtual environment;
authorizing, based on the first user credential, a first avatar of the first user to enter the virtual environment;
obtaining, based on the first user credential, a first user profile associated with the first user, wherein:
each user profile is associated with at least a set of user interface (UI) elements from among a plurality of UI elements configured to be presented in the virtual environment; and
a user associated with a user profile is authorized to view in the virtual environment only a particular set of the plurality of UI elements that are associated with the user profile;
determining a first set of the plurality of UI elements associated with the first user profile of the first user;
rendering the virtual environment to display on the first user device of the first user including one or more UI elements of the first set of the UI elements;
receiving a second request from a second user device associated with a second user to enter the virtual environment, wherein the second request comprises a second user credential that allows the second user to access the virtual environment;
authorizing, based on the second user credential, a second avatar of the second user to enter the virtual environment;
obtaining, based on the second user credential, a second user profile associated with the second user;
determining a second set of the plurality of UI elements associated with the second user profile of the second user; and
rendering the virtual environment to display on the second user device of the second user including one or more UI elements of the second set of the UI elements;
wherein at least some of the first set of the plurality of UI elements associated with the first user are different from at least some of the second set of the plurality of UI elements associated with the second user.

9. The method of claim 8, further comprising:
determining a first field of view of the first user within the virtual environment;
determining a first UI element that is positioned in the first field of view of the user;
determining, based on the first user profile of the first user, whether the first user is authorized to view the first UI element;
in response to determining that the first user is authorized to view the first UI element, rendering the first UI element for display on the first user device in the first field of view within the virtual environment; and
in response to determining that the first user is not authorized to view the first UI element, not rendering the first UI element.

10. The method of claim 9, further comprising:
detecting that the first user has switched from the first field of view to a second field of view within the virtual environment;
in response to detecting that the first user has switched to the second field of view, determining a portion of the plurality of UI elements that are part of the second field of view;
determining, based on the first user profile of the first user, one or more UI elements from the first set of UI elements that are part of the determined portion of the UI elements; and
rendering the one or more UI elements from the first set of UI elements to display on the first user device in the second field of view within the virtual environment.

11. The method of claim 8, further comprising:
receiving, a third request initiated by the first user from the first user device to provide to the second user access to a particular UI element that the first user is authorized to access but the second user is not authorized to access;
verifying, based on the first user profile, that the first user has access to the particular UI element; and
in response to successfully verifying that the first user has access to the particular UI element, rendering the particular UI element for display on the second user device as part of the virtual environment.

12. The method of claim 8, further comprising:
receiving a configuration request from the first user to configure the second user profile associated with the second user, wherein the configuration request comprises one or more UI elements the second user can access within the virtual environment; and
in response to receiving the configuration request, adding the one or more UI elements including the configuration request to the second user profile of the second user.

13. The method of claim 8, wherein each UI element of the plurality of UI elements is uniquely identified by a Non-Fungible Token (NFT) and is stored on one or more computing nodes of a blockchain network.

14. The method of claim 13, wherein the first user profile stores NFTs associated with the first set of UI elements and the second user profile stores NFTs associated with the second set of UI elements.

15. A non-transitory computer-readable medium storing instructions that when executed by a processor cause the processor to:
receive a first request from a first user device associated with a first user to enter a virtual environment, wherein the first request comprises a first user credential that allows the first user access to the virtual environment;
authorize, based on the first user credential, a first avatar of the first user to enter the virtual environment;
obtain, based on the first user credential, a first user profile associated with the first user, wherein:
each user profile is associated with at least a set of user interface (UI) elements from among a plurality of UI elements configured to be presented in the virtual environment; and
a user associated with a user profile is authorized to view in the virtual environment only a particular set of the plurality of UI elements that are associated with the user profile;
determine a first set of the plurality of UI elements associated with the first user profile of the first user;
render the virtual environment to display on the first user device of the first user including one or more UI elements of the first set of the UI elements;
receive a second request from a second user device associated with a second user to enter the virtual environment, wherein the second request comprises a second user credential that allows the second user to access the virtual environment;
authorize, based on the second user credential, a second avatar of the second user to enter the virtual environment;
obtain, based on the second user credential, a second user profile associated with the second user;
determine a second set of the plurality of UI elements associated with the second user profile of the second user; and
render the virtual environment to display on the second user device of the second user including one or more UI elements of the second set of the UI elements;
wherein at least some of the first set of the plurality of UI elements associated with the first user are different from at least some of the second set of the plurality of UI elements associated with the second user.

16. The non-transitory computer-readable medium of claim 15, wherein the instructions further cause the processor to:
determine a first field of view of the first user within the virtual environment;
determine a first UI element that is positioned in the first field of view of the user;
determine, based on the first user profile of the first user, whether the first user is authorized to view the first UI element;
in response to determining that the first user is authorized to view the first UI element, render the first UI element for display on the first user device in the first field of view within the virtual environment; and
in response to determining that the first user is not authorized to view the first UI element, do not render the first UI element.

17. The non-transitory computer-readable medium of claim 16, wherein the instructions further cause the processor to:
detect that the first user has switched from the first field of view to a second field of view within the virtual environment;
in response to detecting that the first user has switched to the second field of view, determine a portion of the plurality of UI elements that are part of the second field of view;
determine, based on the first user profile of the first user, one or more UI elements from the first set of UI elements that are part of the determined portion of the UI elements; and
render the one or more UI elements from the first set of UI elements to display on the first user device in the second field of view within the virtual environment.

18. The non-transitory computer-readable medium of claim 15, wherein the instructions further cause the processor to:
receive, a third request initiated by the first user from the first user device to provide to the second user access to a particular UI element that the first user is authorized to access but the second user is not authorized to access;
verify, based on the first user profile, that the first user has access to the particular UI element; and
in response to successfully verifying that the first user has access to the particular UI element, render the particular UI element for display on the second user device as part of the virtual environment.

19. The non-transitory computer-readable medium of claim 15, wherein the instructions further cause the processor to:
receive a configuration request from the first user to configure the second user profile associated with the second user, wherein the configuration request comprises one or more UI elements the second user can access within the virtual environment; and
in response to receiving the configuration request, add the one or more UI elements including the configuration request to the second user profile of the second user.

20. The non-transitory computer-readable medium of claim 15, wherein each UI element of the plurality of UI elements is uniquely identified by a Non-Fungible Token (NFT) and is stored on one or more computing nodes of a blockchain network.
